(19) United States
(12) Patent Application Publication
(10) Pub. No.: US 2020/0404740 A1
(43) Pub. Date: Dec. 24, 2020

(54) MULTI-DESTINATION CONTROL MESSAGE FOR INTEGRATED ACCESS AND BACKHAUL NODES

(71) Applicant: NOKIA TECHNOLOGIES OY, Espoo (FI)

(72) Inventors: Esa Mikael MALKAMÄKI, Espoo (FI); Amaanat ALI, Espoo (FI); Dawid KOZIOL, Glogow (PL); Mark CUDAK, Rolling Meadows, IL (US)

(21) Appl. No.: 16/975,003

(22) PCT Filed: Feb. 25, 2019
(86) PCT No.: PCT/EP2019/054548

§ 371 Date: Aug. 21, 2020

Related U.S. Application Data
(60) Provisional application No. 62/634,582, filed on Feb. 23, 2018.

(51) Int. Cl. H04W 76/40

(52) U.S. Cl. CPC H04W 76/40; H04W 92/04

(57) ABSTRACT

Various communication systems may benefit from improved signaling of control messages. For example, certain embodiments may benefit from an improved signaling of control messages in 5G or New Radio systems between a donor node and a plurality of integrated access and backhaul nodes. A method may include generating at a network node a control message for a plurality of other nodes. The method may also include transmitting the control message from the network node to the plurality of other nodes via a multicast radio bearer. The multicast radio bearer may connect the plurality of other nodes.

### CROSS REFERENCE TO RELATED APPLICATION

This application claims the benefit of U.S. Provisional Application No. 62/634,582, filed Feb. 23, 2018. The entire content of the above-referenced application is hereby incorporated by reference.

### BACKGROUND

### Field

Various communication systems may benefit from improved signaling of control messages. For example, certain embodiments may benefit from an improved signaling of control messages in 5G or New Radio systems between a donor node and a plurality of integrated access and backhaul nodes.

### Description of the Related Art

Third Generation Partnership Project (3GPP) New Radio (NR) or 5^{th} Generation (5G) technology include functions that allow for minimal manual effort to be performed when deploying a network using NR or 5G technology. For example, one function provided for is automated self-configuration. When utilizing higher frequency bands, NR or 5G technology also provides for easy coverage extension with minimized or no requirements of network planning or re-planning in a fast and cost-efficient manner. To help facilitate the above, a wireless backhaul is used to connect relay nodes, which are also referred to as Integrated Access and Backhaul (IAB) nodes, to each other and to base stations having a fixed connection.

As discussed above, a relay node (RN) or IAB node is included as part of a communication system that utilizes NR or 5G technology. The RN or IAB node also has a wireless backhaul connection, instead of a wired connection, which connects the RN or IAB node to a donor 5G or NR NodeB (DgNB) or to at least one other IAB node. DgNB is a base station with a fixed connection to the network backhaul. A serving DgNB may control the usage of the radio resources in the communication system, and may consider both access and backhaul links as part of the radio resource allocation.

NR or 5G technology further support self-backhauling, in which the same carrier may be used for both backhaul connection and access links. This self-backhauling allows for in-band backhaul operation. A RN or IAB node in the network may have a wireless backhaul connection, instead of a wired connection, to a serving DgNB. The serving DgNB, however, may have overall control of the radio resource usage in the network, and may account for both access and backhaul links when making determinations related to radio resources.

### SUMMARY

In accordance with some embodiments, a method may include generating at a network node a control message for a plurality of other nodes. The method may further include transmitting the control message from the network node to the plurality of other nodes via a multicast radio bearer. The multicast radio bearer may connect the plurality of other nodes.

In accordance with some embodiments, a method may include receiving a control message at a network node via a single multicast radio bearer. The single multicast radio bearer may connect a plurality of network nodes including the network node receiving the control message.

In accordance with some embodiments, an apparatus may include means for generating at a network node a control message for a plurality of other nodes. The apparatus may further include means for transmitting the control message from the network node to the plurality of other nodes via a multicast radio bearer. The multicast radio bearer may connect the plurality of other nodes.

In accordance with some embodiments, an apparatus may include means for receiving a control message at a network node via a single multicast radio bearer. The single multicast radio bearer may connect a plurality of network nodes including the network node receiving the control message.

In accordance with some embodiments, an apparatus may include at least one processor and at least one memory including computer program code. The at least one memory and the computer program code may be configured to, with the at least one processor, cause the apparatus to at least generate at a network node a control message for a plurality of other nodes. The at least one memory and the computer program code may be further configured to, with the at least one processor, cause the apparatus to at least transmit the control message from the network node to the plurality of other nodes via a multicast radio bearer. The multicast radio bearer may connect the plurality of other node.

In accordance with some embodiments, an apparatus may include at least one processor and at least one memory including computer program code. The at least one memory and the computer program code may be configured to, with the at least one processor, cause the apparatus to at least receive a control message at a network node via a single multicast radio bearer. The single multicast radio bearer may connect a plurality of network nodes including the network node receiving the control message.

In accordance with some embodiments, a non-transitory computer readable medium may be encoded with instructions thereon for performing a method. The method may generate at a network node a control message for a plurality of other nodes. The method may further transmit the control message from the network node to the plurality of other nodes via a multicast radio bearer. The multicast radio bearer may connect the plurality of other nodes.

In accordance with some embodiments, a non-transitory computer readable medium may be encoded with instructions thereon for performing a method. The method may receive a control message at a network node via a single multicast radio bearer. The single multicast radio bearer may connect a plurality of network nodes including the network node receiving the control message.

In accordance with some embodiments, a computer program product may perform a method. The method may generate at a network node a control message for a plurality of other nodes. The method may further transmit the control message from the network node to the plurality of other nodes via a multicast radio bearer. The multicast radio bearer may connect the plurality of other nodes.

In accordance with some embodiments, a computer program product may perform a method. The method may receive a control message at a network node via a single multicast radio bearer. The single multicast radio bearer may connect a plurality of network nodes including the network node receiving the control message.

### BRIEF DESCRIPTION OF THE DRAWINGS

For proper understanding of the invention, reference should be made to the accompanying drawings, wherein:

FIG. 1 illustrates an example of a system according to certain embodiments.

FIG. 2 illustrates an example of a flow diagram according to certain embodiments.

FIG. 3 illustrates an example of a flow diagram according to certain embodiments.

FIG. 4 illustrates an example of a protocol data unit according to certain embodiments.

FIG. 5 illustrates an example of protocol stacks according to certain embodiments.

FIG. 6 illustrates an example of a system according to certain embodiments.

### DETAILED DESCRIPTION

In 5G or NR technology, a network may include one or more DgNB and a plurality of IAB nodes. A plurality of IAB nodes may be two or more IAB nodes. Control messages may be transmitted from the DgNB to the plurality of IAB nodes. The control messages, for example, may be used to control radio resource usage of the IAB nodes, as well as configure or distribute routing information, context information, and/or any other aspect of the IAB node. In certain embodiments, the IAB nodes may be positioned in a tree structure in relation to one another, as well as in relation to the DgNB.

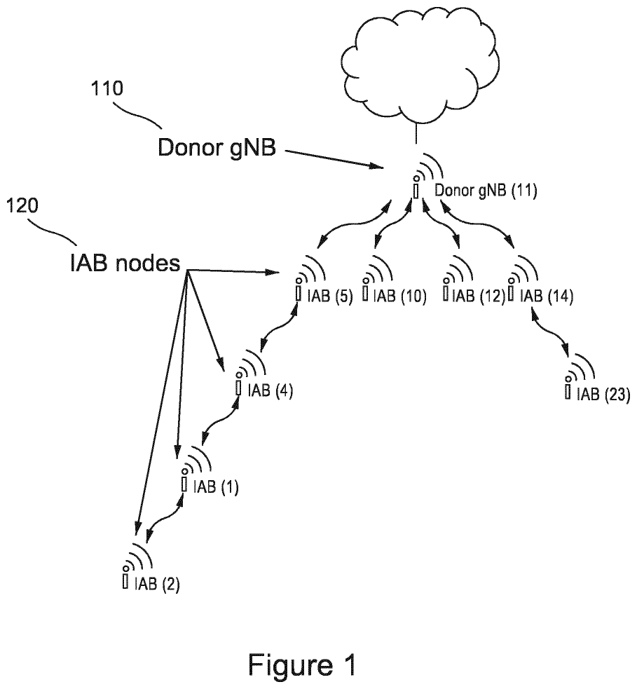

FIG. 1 illustrates an example of a system according to certain embodiments. In particular, FIG. 1 illustrates a DgNB 110 and a plurality of IAB nodes 120 in a tree structure. A tree structure, which may be referred to as a pure tree structure, may be an arrangement in which the plurality of IAB nodes 120 are connected to one another via wireless backhaul links, such that each IAB node is connected to only one parent node, either another IAB node or a DgNB. As seen in FIG. 1, for example, IAB(5) node is connected to DgNB 120. IAB(5) is also connected via a wireless backhaul link to IAB(4), IAB(4) is connected via a wireless backhaul link to IAB(1), and IAB(1) is connected via a wireless backhaul link to IAB(2). In other words, there are four IAB nodes located between IAB(2), which may be a final destination IAB node, and DgNB 110. FIG. 1 also shows that IAB nodes IAB(10), IAB(12) and IAB(14) are connected to DgNB 110, and that IAB(23) is connected to IAB(14). As shown in FIG. 1, the Donor gNB and the IAB nodes connected to DgNB form the IAB tree. A structure in which a plurality IAB nodes are connected to one another via a wireless backhaul link, and a plurality of IAB nodes are connected to DgNB 110, may be referred to as a tree structure.

In some embodiments, a control message is transmitted from DgNB to IAB nodes. The control message, for example, may be used to change the configuration in the IAB node. Traditionally, the control message may only be termination at a specific IAB node. However, in certain embodiments the control message may be destined for a plurality of IAB nodes at the same time, rather than merely being intended to a specific IAB node. A plurality of IAB nodes may be defined as two or more IAB nodes.

A control message, may be transmitted from the DgNB to a plurality of IAB nodes, for example, when a given user equipment (UE) moves to a new cell and/or moves within a cell. The movement of the UE may cause the UE to connect to a different or new IAB node, which may be located in the IAB node tree structure shown in FIG. 1. In some embodiments, the movement of the UE may be characterized as an intracell or intercell handover. The control message, in certain embodiments, may include a routing information update that may be transmitted to the plurality of IAB nodes. Using the structure of FIG. 1, for example, a UE may move and connect to IAB(2), in which case a routing update has to be transmitted to IAB(1), IAB(4), IAB(5), as well as IAB(2). In other words, a control message or a routing update message may be transmitted from DgNB 110 to IAB(1), IAB(4), IAB(5), and IAB(2). When transmitting the control message from DgNB 120 to the plurality of IAB nodes, separate messages for each IAB have to be transmitted through the air interface between DgNB 110 and IAB(5), due to the tree structure of the IAB nodes. Transmitting the same control information as separate control messages to the plurality of IAB nodes, however, wastes air interface resources within the network.

Certain embodiments may therefore utilize a control message to a plurality of IAB nodes. The control message, for example, may be a multi-destination control message, which may be explicitly addressed to a plurality of IAB nodes. In other words, rather than having to send separate messages to each IAB node, a single multi-destination control message may be transmitted from the DgNB to the IAB nodes. In other embodiments, the control message may be a broadcast control message or an along-a-path control message. A broadcast multi-destination control message may target all (or most) of the IAB nodes in the tree. For example, a broadcast multi-destination control message may target all eight IAB nodes shown in FIG. 1.

An along-a-path control message may be a message read by or transmitted to all of the IAB nodes between the DgNB and the final destination IAB node. For example, in FIG. 1 an along-a-path message may be sent to IAB(2) and IAB(5). IAB(4) and IAB(1), however, are located along the path towards IAB(2), and may therefore read the message and perform or act in accordance with the message. IAB(4) and IAB(1) may also forward the message to the next IAB node along the path towards the final destination node. In yet another embodiment, IAB(5) may store a message and forward it at a later point in time upon satisfying a condition. The final destination IAB node may be an IAB node that serves the UE, for example, IAB(2) in FIG. 1. In certain other embodiments, an along-a-path message may be sent or transmitted to IAB(23) in FIG. 1. IAB(14) would also read the message, given that IAB(14) is located between IAB(23) and the DgNB. Other IAB nodes that are not along the path may, however, not receive and read the message. Nodes along the path may be any node included in the tree structure between the source node, such as a DgNB, and the final destination network node, such as a final destination IAB node.

The control message, in some embodiments, may be transmitted from the DgNB to a plurality of IAB nodes via a multicast signaling radio bearer. The multicast signaling radio bearer may connect the plurality of IAB nodes, allowing the control message to be forwarded amongst the plurality of IAB nodes. Using the multicast signaling radio bearer allows for the reduction of signaling overhead by avoiding the transmission of separate control messages to each IAB node. In certain embodiments, the DgNB may receive a response message, such as a multi-origin response message, via the single multicast signaling radio bearer in response to the transmitted control message, from one or several of the plurality of IAB nodes.

A multicast signaling radio bearer may be used to transmit the control message. The multicast signaling radio bearer may use common security, such as common security keys and security algorithms. Each of the plurality of IAB nodes may know the common security parameters, such as the security keys and security algorithms. For example, the security parameter may be generated via a known rule that the IAB nodes and the DgNB may share, or the common security parameter may be a security key that may be shared between the IAB nodes and the DgNB, or between the source node and the destination nodes of the message.

The control message, in some embodiments, may be an onion-like or nested message in which each of the plurality of network nodes, such as IAB nodes, receiving the control message reads a part of the control message that relates to the that specific network node. In other words, the control message may be a multipart message. The network node may then remove the part of the control message pertaining to that specific network node, and forward the rest or the remaining control message to another of the plurality of network nodes. In other embodiments, the control message may be the same for all the plurality of network nodes. The multi-part control message may include different types of control messages for different IAB nodes. The response message may therefore also be a multipart message that includes cause value information. In addition, the response message may include information relating to processing latency of the response message at a given IAB node.

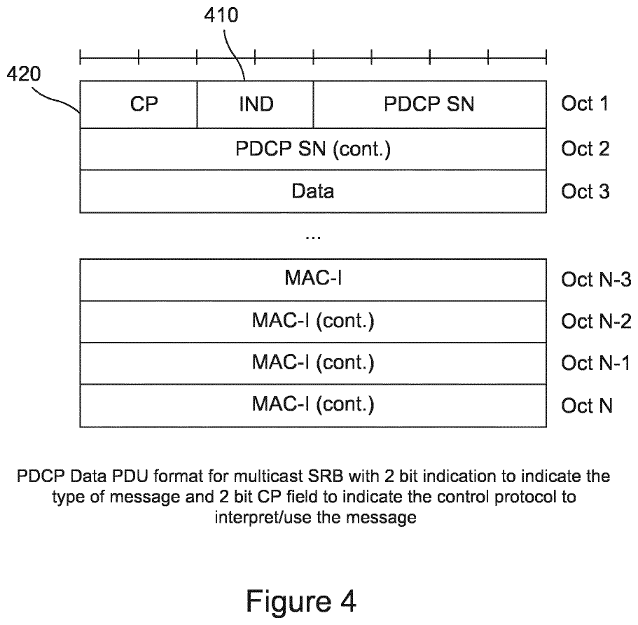

In certain embodiments, the plurality of IAB nodes between the DgNB and the final destination IAB node may recognize either the control message transmitted via the multicast signaling radio bearer or the multicast signaling radio bearer itself based on a logical channel identification (LCID). In other embodiments, the plurality of IAB nodes may recognize the control message transmitted via the signaling radio bearer or the signaling radio bearer itself based on a signaling radio bearer identification, which may be added to an adaptation layer. The signaling radio bearer identification may be signaled to the IAB nodes explicitly when the IAB node is setup. In other embodiments, the identification may be preset or it may be signaled through a system information block that the IAB node may read before initial access of the IAB node. The IAB node may use the LCID or the signaling radio bearer identification to identify or recognize traffic passing through the IAB node. The recognized traffic may be a packet data unit received by the IAB node, which may be termed a control message when the packet data unit includes control information, and/or any other message received by the IAB node. The IAB node receiving the traffic may then forward the traffic to another IAB node connected to the IAB node. In other words, the control messages may be forwarded amongst the plurality of IAB nodes. The IAB node may forward the traffic based on the destination address of the traffic. The destination address may be a UE identification allocated to the UE part of an IAB node, or another IAB node identification. As will be seen in FIG. 4, the IAB node has a UE part and a radio access network (RAN) part.

In other embodiments, the IAB node may pass the traffic to the packet data convergence protocol (PDCP) layer, as well as forwarding the traffic to the next IAB node within the plurality of IAB nodes. The PDCP layer may decipher or decode the traffic or message. The PDCP layer may pass the traffic to the relevant protocol entity, which may be a control protocol entity, such as an F1 application protocol (F1AP), a radio resource control (RRC), and/or a user plane protocol, which may be used with GPRS Tunneling Protocol User Data tunneling (GTP-U). The final destination IAB node, on the other hand, may pass the traffic to the PDCP layer, without forwarding the message to any other IAB node. The PDCP layer may then interpret or decode the data included within the forwarded traffic or message.

A PDCP header, in certain embodiments, may be used to indicate that traffic received at the plurality of IAB nodes is either a control message or another message that an IAB node should forward. The NR PDCP header for a data protocol data unit (PDU) for a signaling radio bearer as specified in TS 38.323, for example, contains four reserved bits. TS 38.323 is hereby incorporated by reference in its entirety. The indication may use any of these four reserved bits in the header of a packet data unit transmitted via the multicast signaling radio bearer. In other embodiments, the indication in the PDCP header may be included in any number of bits within the packet data unit. The PDCP header may indicate to the IAB node that the data is either a broadcast, an along-a-path, or a multi-destination control message. In some embodiments, the PDCP header may indicate to the IAB node that the content of the PDU, in other words the data part of the PDU, should be forwarded to another protocol layer for interpretation. The PDCP header, in some embodiments, may not be ciphered. Therefore, the recipient of the PDCP PDU can read the indication from the header, while only decipher the data part, such as the service data unit (SDU), if the header indicates that the message is for this node.

In certain embodiments, the indication that a given packet data unit is a broadcast, along-a-path, and multi-destination indication may be included in a medium access control (MAC), a radio link control (RLC), or an adaptation layer. In addition, different LCID or signaling radio bearer identification may be used for broadcast, multi-destination, or along-a-path messages. Having the indication in a MAC, a RLC, or an adaptation layer, for example, may allow the plurality of IAB nodes to forward the control message between the IAB nodes without having to decipher or decode the control message. The control message may therefore be forwarded from a given IAB node to another IAB node, or to a final destination IAB node, without having to utilize additional resources for deciphering or decoding the control message.

After receiving the control message, one or more of the plurality of IAB nodes may transmit a response message. In some embodiments, every IAB node may transmit a response to the DgNB separately. In yet another embodiments, however, the DgNB may receive a multi-origin response message. The multi-origin response message may be transmitted using the single multicast signaling radio bearer in response to the transmitted control message. The multi-origin response may be transmitted from a final destination IAB node of the plurality of IAB node, or from one or more of the plurality of IAB nodes.

In certain embodiments, the multi-origin response message may be sent by a final destination IAB node. The final destination node IAB node may be the node that was the final destination of the control message sent by the DgNB. For example, in FIG. 1 the final destination node may be IAB(2). The final destination IAB node may then transmit the response to the DgNB through one or more of the plurality of IAB nodes. In the embodiments shown in FIG. 1, the response message may be transmitted from the final destination IAB node though IAB node tree branch to the DgNB. The one or more of the plurality of IAB nodes that receive the response message may, in some embodiments, add their own response fields to the response message indicating that the response message has passed through the one or more of the plurality of IAB nodes. In other embodiments, however, the one or more of the plurality of IAB nodes do not add their own fields to the response message. Instead, the response message may be received from the final destination IAB nodes, which implies that the original control message as well as the response message has passed through all the intermediate IAB nodes between the final destination IAB node and DgNB.

If the response message indicates the status of the IAB node, the one or more of the plurality of IAB nodes may amend the response message to indicate the status of those one or more IAB nodes. The response fields added by the individual IAB node may therefore indicate a status of that IAB node. The status of an IAB node may be, for example, a buffer status or a load status. The response message can also indicate the configuration of the IAB node.

The forwarding amongst the plurality of IAB nodes within the single multicast signaling radio bearer may be based on a node type. In other words, the IAB node may differentiate between access UEs attached to the IAB node and other IAB nodes which connect like the attached UEs. In other words, a parent IAB node may distinguish between normal access UEs and the UE part of an IAB node. In some embodiments, the IAB node receiving a message via the multicast signaling radio bearer may forward the message through the multicast signaling radio bearer only to those nodes or UEs that have a particular IAB functionality falling.

As discussed above, the multi-destination control messages may be used for control of IAB nodes. For example, the control message may be used to transmit routing information to the plurality of IAB nodes. Each IAB node through which the control message is transmitted may pick or extrapolate the information relevant to the individual IAB node from the control message. In another example, the control message may include updated UE context information. The updated context information may be transmitted when a new UE attaches to one of the plurality of IAB nodes. When a UE attaches to an IAB node, the plurality of IAB nodes along the path in the tree structure should be made aware of the UE context, such as bearer information and/or logical channel priorities. In a further example, the control message may be a stop transmission indication. The stop transmission indication may be sent when a UE has been handed over or moved to another IAB node. Each of the plurality of IAB nodes receiving the stop transmission indication may stop forwarding or transmitting data to the UE, unless the new IAB node is located within the new path that includes the IAB node to which the new UE moved or attached.

Once the control message is received by one or more of the plurality of IAB nodes, the IAB nodes may use the information included within the control message to update various administrative settings or configurations. The administrative settings or configuration may relate to UE context information and/or routing information. In other embodiments, once the control message is received the IAB nodes may stop transmitting data to the UE, or perform any other action requested by the control message.

The following is a numerical example of some of the embodiments described above, and an explanation of the improvements to computer-related technology, as well as performance and computational complexity, caused by the embodiments. The DgNB, for example, may reconfigure the path leading to a final destination IAB node, such as IAB(2) shown in FIG. 1. Reconfiguring means that a control message may be transmitted to not only the final destination IAB node, but also to the plurality of IAB nodes located between the DgNB and the final destination IAB node. In the embodiment illustrated in FIG. 1, the control message may be transmitted from the DgNB to IAB(5), IAB(4), IAB(1), and IAB(2). This is due to the tree structure of the plurality of IAB nodes shown in FIG. 1.

When each IAB node receives a separate control message and subsequently transmits a response to the control message, each IAB node may perform 1×2 processing. For the control message transmitted from the DgNB to the IAB(2), four different forwarding actions would need to be performed in one direction, and another four different reverse forwarding actions would need to be performed in response to the control message. Taking into account the plurality of IAB nodes to which the control message may be transmitted in the embodiment shown in FIG. 1, twenty total forwards would occur. The twenty total forwards may be as follows: DgNB to IAB(2), would require 4×2 forwards, 1×2 processing, DgNB to IAB(1), would require 3×2 forwards, 1×2 processing, DgNB to IAB(4), would require 2×2 forwards, 1×2 processing, and DgNB to IAB(5), would require 1×2 forwards, 1×2 processing.

Using the embodiments described above, in which a control message is transmitted to a plurality of IAB nodes via a single multicast signaling radio bearer, on the other hand, would only require a plurality of eight total forwards, four for the control message and four for the response message. The eight total forwards may be as follows: DgNB to IAB(2), would require 4×2 forwards, and 4×2 processing. The above embodiments, therefore, lead to a reduction of signaling overhead by avoiding transmitting the same message separately to each IAB node. Using a multicast signaling radio bearer may lead to a reduction of the total forwarding actions performed by the plurality of IAB node by as much as 60%, for example from 20 to 8 forwarding actions, thereby increasing the air interface capacity, as well as the capacity of the air interface due to retransmissions. The above embodiments may be especially impactful in the air interface located between the DgNB and the first IAB node located closest to the DgNB, such as IAB(5) in DgNB, where all the traffic intended to IAB(5) and IAB nodes in the subtree under IAB(5) are forwarded.

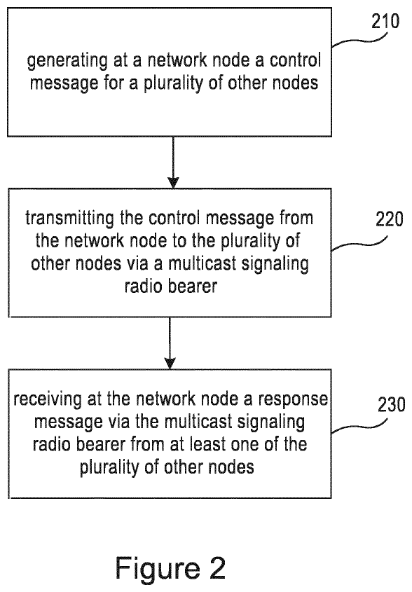

FIG. 2 illustrates an example of a flow diagram according to certain embodiments. In particular, FIG. 2 may illustrate a method or process performed by the source network node of the control message, also known as the controlling node, such as the DgNB. In other embodiments, the method or process illustrated in FIG. 2 may be performed in one of the plurality of IAB nodes located between the DgNB and the final destination IAB node. In step 210, a network node, for example, a donor node, such as the DgNB, or an IAB node, may generate a control message for a plurality of other network nodes.

In step 220, the network node may transmit the control message to the plurality of other nodes, such as IAB nodes, via a multicast signaling radio bearer. The multicast signaling radio bearer may connect the plurality of other nodes, and the control message may be forwarded amongst the plurality of other nodes. In some embodiments, there may only be a single multicast signaling radio bearer. The control message may be forwarded amongst the plurality of other nodes via one or more backhaul links. In some embodiments, the plurality of IAB nodes may be structured as a tree of IAB nodes. In another embodiment, the plurality of other nodes may be connected to each other in a multi-hop chain. As discussed above, the use of the multicast signaling radio bearer connecting the plurality of other nodes may prevent separate control messages from being transmitted to each of the plurality of other nodes, when the multicast signaling radio bearer and the control message passes through the plurality of the nodes.

In certain embodiments, the control message may be multi-destination control message. For example, the control message may be a broadcast control message, an along-a-path control message, or a multi-destination control message with explicit destination addresses. The multicast signaling radio bearer may use a common security parameter. The control message in the multicast signaling radio bearer may be detected by the plurality of IAB nodes via at least one of LCID or a signal radio bearer identification. The plurality of the IAB nodes may forward the control message to a higher protocol layer. The higher protocol layer may be a PDCP layer or another layer above PDCP. In some embodiments, the control message may have a PDCP layer header associated with the multicast signaling radio bearer. The control message may also include an indication of the final destination node amongst the plurality of other nodes. The indication may be in a MAC layer, RLC layer, or an adaptation layer header.

Once the control message is received by one or more of the plurality of IAB nodes, the IAB nodes may use the information included within the control message to update various settings or configurations. The settings or configurations may be related to at least one of UE context information, UE logical channel quality of service (QoS) mapping, and/or routing information based on the control message. The settings, for example, may be administrative settings. The UE logical channel QoS mappings may include the QoS parameters or simply the logical channel priority. In other embodiments, once the control message is received the IAB nodes may stop transmitting or forwarding data to the UE. In step 230, the source node, such as the DgNB, and/or one of the plurality of other nodes, may receive a response message via the single multicast signaling radio bearer in response to the transmitted control message from at least one of the plurality of other nodes. In certain embodiments, the response message may be a multi-origin or a source response message.

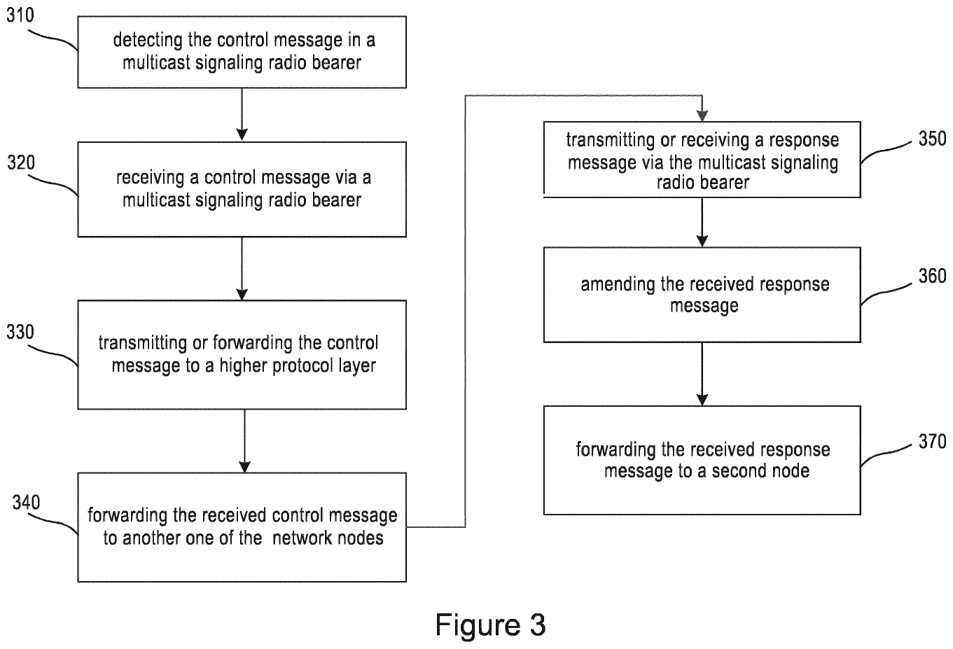

FIG. 3 illustrates an example of a flow diagram according to certain embodiments. In particular, FIG. 3 illustrates a method performed by a network node, such as an IAB node, included as part of the plurality of network nodes. The network node shown in FIG. 3 may be one of the plurality of other nodes illustrated in FIG. 2. In step 310, the network node may detect a control message in a multicast signaling radio bearer. The control message may be a multi-destination control message. The network node may detect the control message in the multicast signaling radio bearer via at least one of LCID or a signal radio bearer identification. In step 320, the network node may receive the control message via a multicast signaling radio bearer. The control message may be received from a source node, such as a DgNB, or another network node, such as an IAB node. The donor node may be a DgNB. The multicast signaling radio bearer may connect or may pass through a plurality of network nodes including the network node receiving the control message. In certain embodiments, the network node may be a final destination node, such as a final destination IAB node. For example, the network node may be IAB(2) in FIG. 1.

Once the control message is received, the IAB node may update various settings or configurations. The settings or configurations may be related to at least one of UE context information and/or routing information based on the control message. In other embodiments, once the control message is received the network node may stop transmitting or forwarding data to the UE based on the control message. In step 330, the network node may forward the received control message to a higher protocol layer. The higher protocol layer may be a packet data convergence protocol layer or another layer above the PDCP layer. In step 340, the network node may forward the received control message to another of the plurality of network nodes.

In step 350, the network node, such as the IAB node, may transmit or receive a response message in the multicast signaling radio bearer in response to the received control message. The response message may be a multi-source or a multi-origin response message. The multicast signaling radio bearer may be detected via at least one of LCID or a signal radio bearer identification. In step 360, the network node may amend the received response message with information related to the network node itself. The information may be, for example, a buffer status or a load status of the network node. The information, in another embodiment, may also indicate a configuration of the network node. In step 370, the network node may forward the received response message to another one of the plurality of network nodes. The another one of the plurality of network nodes may be an IAB node or a DgNB having a fixed connection.

FIG. 4 illustrates an example of a protocol data unit according to certain embodiments. In particular, FIG. 4 illustrates an example PDCP PDU structure for multicast SRB. In the example show in FIG. 4, two resource (R) bits have been replaced with an indication (IND) field 410 which indicates the type of message. For instance, an indication of 01 may mean that the PDU is included in broadcast type message to be forwarded to all child nodes, while an indication of 10 may mean that the PDU is included in an along-a-path type message which may be forwarded to next child node along the path towards the final destination node. On the other hand, an indication of 11 may mean a multi-destination type message with explicit destination identifications. The multi-destination type message may require additional fields in the PDCP PDU header (not shown in the figure). For example, one additional field may be a ‘number of destination identifications’ field, and then separately as many destination identifications as the field indicates. In addition to IND field 410, the PDCP PDU header of multicast SRB may include a two bit control protocol (CP) field 420 which may tell the receiving node which control protocol may be used to interpret the control message. For example, a CP field of 00 may indicate an RRC protocol, while a CP field of 01 may indicate F1AP protocol.

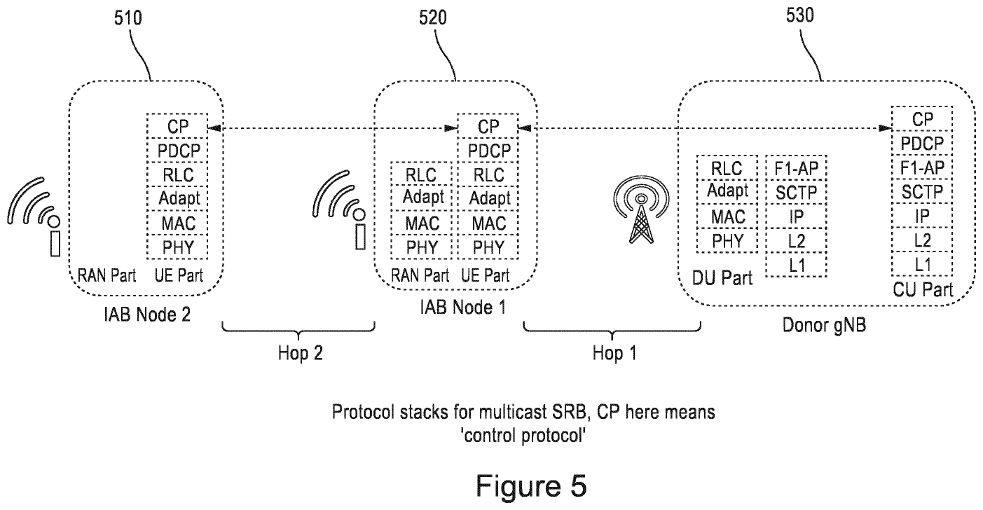

FIG. 5 illustrates an example of protocol stacks according to certain embodiments. In particular, FIG. 5 illustrates example protocol stacks for DgNB central unit (CU) and distribution unit (DU) parts, and for IAB node 510 and IAB node 520 according to certain embodiments. In the embodiment shown in FIG. 5, the control message may have been sent with IAB node 510 acting as the final destination node. When intermediate node IAB node 520 receives the message on the multicast signaling radio bearer, it may decode the PDCP header, such as the header shown in FIG. 4, and act based on the IND field and/or CP field included within the PDCP header.

In certain embodiments, the IND field may indicate that the PDU or control message including the PDU is an along-a-path type message, and IAB node 520 may forward the message to IAB node 510 accordingly. IAB node 520 may also decipher the message in the PDCP layer, and deliver it to a CP entity according to the CP field in the PDCP PDU header. The protocol layers physical (PHY), MAC, and/or RLC may be according to NR specifications. The adaptation layer (Adapt) may include a UE identification, an IAB node identification, a radio bearer identification, and may perform routing, for example. Adaptation layer may also be above the RLC layer in some embodiments. The UE identification may also be added to MAC subheader instead of or in addition to the adaptation layer. The protocol stacks located between DgNB CU and DU may be standard F1 interface protocols.

In certain embodiments, a multicast signaling radio bearer may connect all of IAB node 510, IAB node 520, and DgNB 530. In certain embodiments, only a single signaling radio bearer may connect all of IAB node 510, IAB node 520, and DgNB 530. The multicast signaling radio bearer may be attached to the CP located in IAB nodes 510 and 520, as well as in the central unit (CU) of DgNB 530.

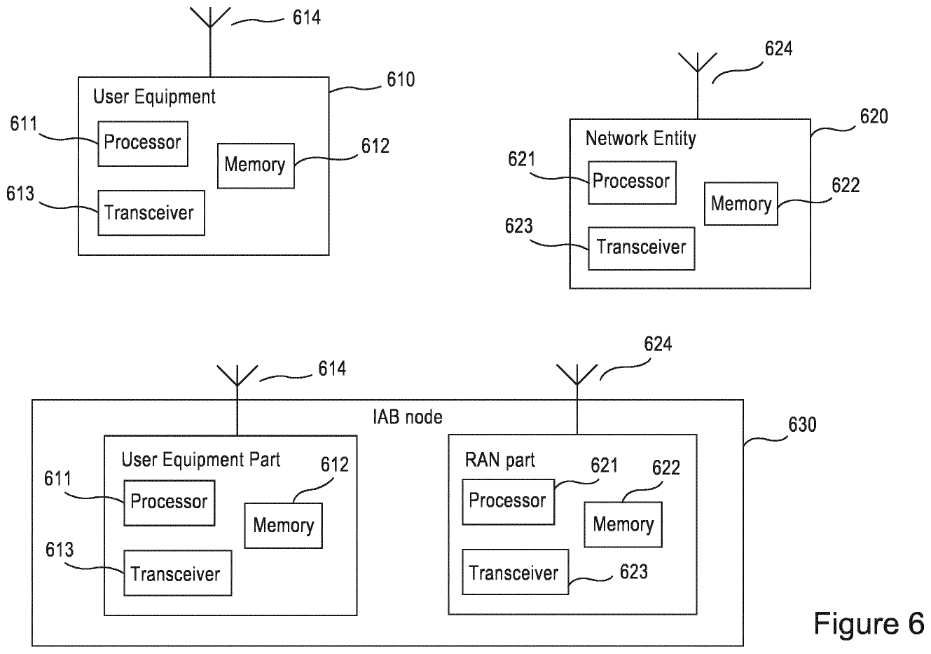

FIG. 6 illustrates a system according to certain embodiments. It should be understood that each block in FIGS. 1-5 may be implemented by various means or their combinations, such as hardware, software, firmware, one or more processors and/or circuitry. In one embodiment, a system may include several devices, such as, for example, a network entity 620 or a UE 610. The system may include more than one UE 610 and more one network entity 620, although only one network entity is shown for the purposes of illustration. The network entity may be a network node, an access node, a base station, an evolved NodeB (eNB), a 5G or NR NodeB (gNB), a donor gNB, an IAB node, a host, a server, or any of the other access or network node discussed herein.

In certain embodiments, an IAB node 630, may include a UE part which is similar to UE 610 for communication with the donor node or a parent IAB node's RAN part, in a multi-hop embodiment, and a RAN part which may be similar to a network entity 620 for communication with access UEs or a next hop IAB node UE part. In certain embodiments, therefore, a single IAB node may include at least two processors 611, 621, at least two transceivers 613, 623, at least two memories 612, 622, and at least two antennas 614, 624. In other embodiments the processors, transceivers, memories and/or antennas may be shared between the UE part and the RAN part of the IAB node.

Each of these devices may include at least one processor or control unit or module, respectively indicated as 611 and 621. At least one memory may be provided in each device, and indicated as 612 and 622, respectively. The memory may include computer program instructions or computer code contained therein. One or more transceiver 613 and 623 may be provided, and each device may also include an antenna, respectively illustrated as 614 and 624. Although only one antenna each is shown, many antennas and multiple antenna elements may be provided to each of the devices. Higher category UEs generally include multiple antenna panels. Other configurations of these devices, for example, may be provided. For example, network entity 620 and UE 610 may be additionally configured for wired communication, in addition to wireless communication, and in such a case antennas 614 and 624 may illustrate any form of communication hardware, without being limited to merely an antenna.

Transceivers 613 and 623 may each, independently, be a transmitter, a receiver, or both a transmitter and a receiver, or a unit or device that may be configured both for transmission and reception. In other embodiments, the network entity may have at least one separate receiver or transmitter. The transmitter and/or receiver (as far as radio parts are concerned) may also be implemented as a remote radio head which is not located in the device itself, but in a mast, for example. The operations and functionalities may be performed in different entities, such as nodes, hosts or servers, in a flexible manner. In other words, division of labor may vary case by case. One possible use is to make a network node deliver local content. One or more functionalities may also be implemented as virtual application(s) in software that can run on a server.

A user device or user equipment may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof. In other embodiments, the UE may be a machine type communication (MTC) device or an Internet of Things device, which may not require human interaction, such as a sensor, a meter, an actuator.

In some embodiments, an apparatus, such as user equipment 610 or network entity 620, may include means for performing or carrying out embodiments described above in relation to FIGS. 1-5. In certain embodiments, the apparatus may include at least one memory including computer program code and at least one processor. The at least one memory including computer program code can be configured to, with the at least one processor, cause the apparatus at least to perform any of the processes described herein. The apparatus, for example, may be user equipment 610 or network entity 620.

Processors 611 and 621 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 612 and 622 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network entity 620 or UE 610, to perform any of the processes described above (see, for example, FIGS. 1-5). Therefore, in certain embodiments, a non-transitory computer-readable medium may be encoded with computer instructions or one or more computer program (such as added or updated software routine, applet or macro) that, when executed in hardware, may perform a process such as one of the processes described herein. In other embodiments, a computer program product may encode instructions for performing any of the processes described above, or a computer program product embodied in a non-transitory computer-readable medium and encoding instructions that, when executed in hardware, perform any of the processes describes above. Computer programs may be coded by a programming language, which may be a high-level programming language, such as objective-C, C, C++, C #, Java, etc., or a low-level programming language, such as a machine language, or assembler. Alternatively, certain embodiments may be performed entirely in hardware.

In certain embodiments, an apparatus may include circuitry configured to perform any of the processes or functions illustrated in FIGS. 1-5. Circuitry, in one example, may be hardware-only circuit implementations, such as analog and/or digital circuitry. Circuitry, in another example, may be a combination of hardware circuits and software, such as a combination of analog and/or digital hardware circuit(s) with software or firmware, and/or any portions of hardware processor(s) with software (including digital signal processor(s)), software, and at least one memory that work together to cause an apparatus to perform various processes or functions. In yet another example, circuitry may be hardware circuit(s) and or processor(s), such as a microprocessor(s) or a portion of a microprocessor(s), that include software, such as firmware for operation. Software in circuitry may not be present when it is not needed for the operation of the hardware.

Specific examples of circuitry may be content coding circuitry, content decoding circuitry, processing circuitry, image generation circuitry, data analysis circuitry, or discrete circuitry. The term circuitry may also be, for example, a baseband integrated circuit or processor integrated circuit for a mobile device, a network entity, or a similar integrated circuit in server, a cellular network device, or other computing or network device.

Furthermore, although FIG. 6 illustrates a system including a network entity 620 and UE 610, certain embodiments may be applicable to other configurations, and configurations involving additional elements, as illustrated and discussed herein. For example, multiple user equipment devices and multiple network entities may be present, or other nodes providing similar functionality, such as nodes that combine the functionality of a user equipment and an network entity, such as a relay node. The UE 610 may likewise be provided with a variety of configurations for communication other than communication network entity 620. For example, the UE 610 may be configured for device-to-device, machine-to-machine, and/or vehicle-to-vehicle transmissions.

The above embodiments may provide for significant improvements to the functioning of a network and/or to the functioning of the user equipment and the IAB nodes within the network. As discussed above, the above embodiments provide an improvement to the computer-related technology by decreasing the overhead used for forwarding messages, allowing for resources to be used in other locations throughout the network. Using the single multicast signaling radio bearer to transmit a control message to a plurality of IAB nodes may therefore help to decrease the amount of network resources used for transmitting a control message, thereby allowing for those network resources to be conserved or to be used for other network functions. This reduction of network resources also prevents the establishment of a potential bottleneck between the DgNB and the first IAB node located closest to the DgNB.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. Although many of the above embodiments are directed to 5G or NR technology, other embodiments may apply to other 3GPP technology, or technology of any other telecommunications regulatory body. For example, the embodiments may apply to Long Term Evolution (LTE), LTE-advanced (LTE-A), Third Generation (3G), Fourth Generation (4G), or IoT technology.

### Partial Glossary

AMF Access and Mobility Function

BH Backhaul

CP Control Protocol

DRB Data Radio Bearer

F1 AP F1 Application Protocol

IAB Integrated Access and Backhaul

MAC Media Access Control

PDCP Packet Data Convergence Protocol

PDU Protocol Data Unit

RAN Radio Access Network

RN Relay Node

RRC Radio Resource Control

SCTP Stream Control Transmission Protocol

SRB Signalling Radio Bearer

UE User Equipment

UPF User Plane Function

According to a first embodiment, a method may include generating at a network node a control message for a plurality of other nodes. The method may also include transmitting the control message from the network node to the plurality of other nodes via a multicast signaling radio bearer. The multicast signaling radio bearer may connect the plurality of other nodes.

In a variant, the method may include receiving at the network node a response message via the multicast signaling radio bearer in response to the transmitted control message from at least one of the plurality of other nodes.

In variant, the control message may be forwarded amongst the plurality of other nodes.

In a variant, the control message may be forwarded amongst the plurality of other nodes via one or more backhaul links.

In a variant, the use of the multicast signaling radio bearer connecting the plurality of other nodes may prevent separate control messages from being transmitted to each of the plurality of other nodes, when the multicast signaling radio bearer and the control message passes through the plurality of the nodes.

In a further variant, the response message may be a multi-origin response message.

In another variant, the control message may be a multi-destination control message.

In a further variant, the control massage may be a broadcast control message, an along-a-path control message, or a multi-destination control message with explicit destination addresses.

In another variant, the multicast signaling radio bearer may use a common security parameter.

In a further variant, the plurality of other nodes may forward the control message to a higher protocol layer. The higher protocol layer may be a packet data convergence protocol layer or another layer above the packet data convergence protocol layer.

In a variant, the control message may have a packet data convergence protocol layer header associated with the multicast signaling radio bearer.

In another variant, the control message may include an indication of the final destination node amongst the plurality of other nodes. The indication may be in a medium access control layer, a radio link control layer, or an adaptation layer.

In a further variant, the plurality of other may update settings or configurations.

In a variant, the settings or the configuration may be related to at least one of user equipment context information or routing information based on the control message.

In another variant, one or more of the plurality of integrated access and backhaul nodes may stop forwarding or transmitting data to the user equipment based on the control message.

In an additional variant, the plurality of other nodes may be structured as a tree of nodes.

In a further variant, the response message may be a multi-origin response message or a source response message.

According to a second embodiment, a method may include receiving a control message at a network node via a single multicast signaling radio bearer. The single multicast signaling radio bearer may connect a plurality of network nodes including the network node receiving the control message.

In a variant, the method may include transmitting or receiving a response message via the multicast signaling radio bearer in response to the received control message.

In a variant, the control message may be received from the source node or another network node.

In another variant, the response message may be a multi-source response message or a multi-origin response message.

In an additional variant, the method may include amending the received response message with information related to the network node itself.

In a further variant, the information may be a buffer status or a load status of the network node.

In another variant, the information may indicate a configuration of the network node.

In a variant, the method may include forwarding the received response message to another one of the plurality of network nodes.

In a variant, the network node may be a final destination network node.

In an additional variant, the method may include forwarding the control message from the network node to a higher protocol layer. The higher protocol layer may be a packet data convergence protocol layer or another layer above the packet data convergence protocol layer.

In another variant, the method may include forwarding the received control message from the network node to another of the plurality of network nodes.

In a further variant, the method may include detecting the control message in the multicast signaling radio bearer.

In a variant, the control message may be a multi-destination control message.

In another variant, the network node may use at least one of logical channel identification or a signal radio bearer identification to detect the control message in the multicast signaling radio bearer.

In an additional variant, the use of the multicast signaling radio bearer connecting the plurality of network nodes may prevent separate control messages from being transmitted to each of the plurality of network nodes, when the multicast signaling radio bearer and the control message passes through the plurality of the network nodes.

In a variant, the response message may be a multi-origin response message.

In another variant, the multicast signaling radio bearer may use a common security parameter.

In a further variant, the control message may have a packet data convergence protocol layer header associated with the multicast signaling radio bearer.

In an additional variant, the control message may include an indication of the final destination node amongst the plurality of other nodes. The indication may be in a medium access control layer, a radio link control layer, or an adaptation layer.

In a variant, the plurality of network nodes may be structured as a tree of network nodes.

In a further variant, the network node may update settings or configurations.

In another variant, the settings or the configuration may be related to at least one of user equipment context information or routing information based on the control message.

In another variant, the network node may stop forwarding or transmitting data to the user equipment based on the control message.

In an additional variant, the plurality of network nodes may be structured as a tree of network nodes.

According to a third and fourth embodiment, an apparatus can include at least one processor and at least one memory and computer program code. The at least one memory and the computer program code can be configured to, with the at least one processor, cause the apparatus at least to perform a method according to the first embodiment and the second embodiment, and any of its variants.

According a fifth and sixth embodiment, an apparatus can include means for performing the method according to the first embodiment and the second embodiment, and any of its variants.

According to a seventh and an eighth embodiment, a computer program product may encode instructions for performing a process including a method according to the first embodiment and the second embodiment, and any of its variants.

According to a ninth and a tenth embodiment, a non-transitory computer-readable medium may encode instructions that, when executed in hardware, perform a process including a method according to the first embodiment and the second embodiment, and any of its variants.

According to an eleventh and a twelve embodiment, a computer program code may include instructions for performing a method according to the first embodiment and the second embodiment, and any of its variants.

1. A method, comprising:
generating at a network node a control message for a plurality of other nodes; and
transmitting the control message from the network node to the plurality of other nodes via a multicast radio bearer, wherein
the multicast radio bearer connects the plurality of other nodes.

2. The method of claim 1, further comprising receiving at the network node a response message via the multicast radio bearer in response to the transmitted control message from at least one of the plurality of other nodes.

3. The method of claim 1, wherein the control message is forwarded amongst the plurality of other nodes.

4. The method of claim 1, wherein the control message is interpreted by the network node before being forwarded amongst the plurality of other nodes.

5. The method of claim 1, wherein the control message is modified by the network node before being forwarded amongst the plurality of other nodes.

6. The method of claim 1, wherein the control message is modified by at least one node of the plurality of other nodes.

7. The method of claim 1, wherein the at least one node of the plurality of other nodes add at least one response and/or at least one additional information element to the control message.

8. The method of claim 1, wherein the control message is forwarded amongst the plurality of other nodes via one or more backhaul links.

9. The method of claim 1, wherein the control message is forwarded amongst the plurality of other nodes via one or more backhaul links.

10. The method of claim 1, wherein the use of the multicast radio bearer connecting the plurality of other nodes prevent separate control messages from being transmitted to each of the plurality of other nodes, when the multicast radio bearer and the control message passes through the plurality of the nodes.

11. The method of claim 1, wherein the response message comprises at least one response message or at least one source response message and has been forwarded through, and modified to include additional responses by, at least one of the plurality of nodes.

12. The method of claim 1, wherein a final destination node adds at least one additional response message and transmits at least one combined response message to the source node corresponding with the source response message.

13. The method of claim 1, wherein the at least one combined response message is transmitted via at least one unicast bearer.

14. The method of claim 1, wherein the control message comprises a multi-destination control message.

15. The method of claim 1, wherein the control message comprises a broadcast control message, an along-a-path control message, or a multi-destination control message with explicit destination addresses.

16. The method of claim 1, wherein the multicast radio bearer uses a common security parameter.

17. The method of claim 1, wherein the plurality of other nodes forward the control message to a higher protocol layer, wherein the higher protocol layer comprises a packet data convergence protocol layer or another layer above the packet data convergence protocol layer.

18. The method of claim 1, wherein the control message comprises a packet data convergence protocol layer header associated with the multicast radio bearer.

19.-23. (canceled)

24. A method comprising:
receiving a control message at a network node via a single multicast radio bearer, wherein the single multicast radio bearer connects a plurality of network nodes including the network node receiving the control message.

25.-47. (canceled)

48. An apparatus comprising:
at least one processor; and
at least one memory and computer program code, wherein the at least one memory and the computer program code are configured to, with the at least one processor, cause the apparatus at least to perform a method according to claim 1.

49. (canceled)

50. (canceled)

51. A non-transitory computer-readable medium comprising program instructions stored thereon for performing a method according to claim 1.

52. An apparatus comprising:
at least one processor; and
at least one memory and computer program code, wherein the at least one memory and the computer program code are configured to, with the at least one processor, cause the apparatus at least to perform a method according to claim 24.

53. A non-transitory computer-readable medium comprising program instructions stored thereon for performing a method according to claim 24.
